(19) United States
(12) Patent Application Publication
(10) Pub. No.: US 2026/0343164 A1
(43) Pub. Date: Oct. 29, 2026

(54) COMPUTER-IMPLEMENTED METHOD FOR AUDIO CONTROL, ELECTRONIC DEVICE AND STORAGE MEDIUM

(71) Applicant: LINKPLAY TECHNOLOGY INC. NANJING, Nanjing (CN)

(72) Inventors: Jiaxin LI, Nanjing (CN); Dongsheng LIAO, Nanjing (CN); Lifeng ZHAO, Nanjing (CN); Pu YANG, Nanjing (CN)

(73) Assignee: LINKPLAY TECHNOLOGY INC. NANJING, Nanjing (CN)

(21) Appl. No.: 19/650,566

(22) Filed: Apr. 17, 2026

Related U.S. Application Data
(63) Continuation of application No. PCT/CN2025/080412, filed on Mar. 4, 2025.

(30) Foreign Application Priority Data
Sep. 23, 2024 (CN) 202411327296.8

(51) Int. Cl. H04S 7/00; H04S 3/00

(52) U.S. Cl. CPC H04S 7/301; H04S 3/008; H04S 2400/01; H04S 2400/13; H04S 2400/15; H04S 2420/07

(57) ABSTRACT

A computer-implemented method for audio control includes: performing sound effect testing on a target space based on a specified measurement signal, and obtaining environmental response information, where the environmental response information includes impulse response information and post-separation impulse response information; analyzing the environmental response information, and obtaining acoustic characteristics information of the target space; performing compensation processing on audio to be processed based on the acoustic characteristic information, and obtaining adjusted audio; adjusting gains of a plurality of channels corresponding to the adjusted audio, and obtaining re-adjusted audio; and performing multi-channel collaborative optimization processing on the re-adjusted audio, and obtaining audio with a target effect.

### CROSS-REFERENCE TO RELATED APPLICATIONS

This application is a continuation of International Application No. PCT/CN2025/080412, filed on Mar. 4, 2025, which claims priority to Chinese Patent Application No. 202411327296.8, filed on Sep. 23, 2024. The disclosures of the above-mentioned applications are hereby incorporated by reference in their entireties.

### TECHNICAL FIELD

The present disclosure relates to the field of audio control technologies, in particular to a computer-implemented method for audio control, an electronic device and a storage medium.

### BACKGROUND

An audio system, also known as a sound system or audio frequency system, is a collection of devices and technologies for generating, processing, transmitting and playing sound. Traditional audio systems often use preset audio parameters, which cannot effectively adapt to the characteristics of different playback environments. As a result, the sound quality in practical applications differs significantly from the ideal state, leading to obvious peaks and valleys in the low-frequency response, thus affecting the overall listening experience.

### SUMMARY

In a first aspect, the present disclosure provides a computer-implemented method for audio control, including: performing sound effect testing on a target space based on a specified measurement signal, and obtaining environmental response information, where the environmental response information includes impulse response information and post-separation impulse response information; analyzing the environmental response information, and obtaining acoustic characteristics information of the target space; performing compensation processing on audio to be processed based on the acoustic characteristic information, and obtaining adjusted audio; adjusting gains of a plurality of channels corresponding to the adjusted audio, and obtaining re-adjusted audio; and performing multi-channel collaborative optimization processing on the re-adjusted audio, and obtaining audio with a target effect.

In a second aspect, the present disclosure provides an electronic device including: a processor and a memory, where the memory has stored therein instructions executable by the processor, and the instructions, when executed by the processor, cause the processor to perform the following steps: performing sound effect testing on a target space based on a specified measurement signal, and obtaining environmental response information, where the environmental response information includes impulse response information and post-separation impulse response information; analyzing the environmental response information, and obtaining acoustic characteristics information of the target space; performing compensation processing on audio to be processed based on the acoustic characteristic information, and obtaining adjusted audio; adjusting gains of a plurality of channels corresponding to the adjusted audio, and obtaining re-adjusted audio; and performing multi-channel collaborative optimization processing on the re-adjusted audio, and obtaining audio with a target effect.

In a third aspect, the present disclosure provides a computer readable storage medium having a computer program stored thereon, the computer program, when executed by a processor, cause the processor to perform the following steps: performing sound effect testing on a target space based on a specified measurement signal, and obtaining environmental response information, where the environmental response information includes impulse response information and post-separation impulse response information; analyzing the environmental response information, and obtaining acoustic characteristics information of the target space; performing compensation processing on audio to be processed based on the acoustic characteristic information, and obtaining adjusted audio; adjusting gains of a plurality of channels corresponding to the adjusted audio, and obtaining re-adjusted audio; and performing multi-channel collaborative optimization processing on the re-adjusted audio, and obtaining audio with a target effect.

### BRIEF DESCRIPTION OF THE DRAWINGS

FIG. 1 is a schematic diagram of an electronic device according to the embodiments of the present disclosure.

FIG. 2 is a flow chart illustrating a computer-implemented method for audio control according to the embodiments of the present disclosure.

FIG. 3 is another flow chart illustrating the computer-implemented method for audio control according to the embodiments of the present disclosure.

### DETAILED DESCRIPTION OF THE EMBODIMENTS

The present disclosure provides a computer-implemented method for audio control, an electronic device and a storage medium, which greatly improve an overall listening experience for the audio and continuously optimize audio output.

Terms such as “first”, “second”, “third” and “fourth” (if any) in the description, claims and the drawings of the present disclosure are used to differentiate similar objects, and not necessarily used to describe a specific sequence or order. It should be appreciated that the data used in this way may be interchanged under an appropriate circumstance, so that the embodiments of the present disclosure described herein may be implemented in a sequence other than those illustrated or described herein. Moreover, terms “include”, “have” and any other variation thereof are intended to encompass non-exclusive inclusion, such that a process, method, system, product or device including a series of steps or units includes not only those steps or elements, but also other steps or units not explicitly listed, or steps or units inherent in the process, method, system, product or device.

The present disclosure provides a computer-implemented method for audio control, an electronic device and a storage medium, which are mainly applied in an audio system.

As can be appreciated, an entity for performing the present disclosure may be a terminal, a server, or an audio system, which will not be particularly defined herein. The present disclosure is illustrated with the server as the entity.

The present disclosure further provides an electronic device, including a processor and a memory. The memory has stored therein instructions executable by the processor, and the instructions, when executed by the processor, cause the processor to perform the computer-implemented method for audio control as described above. This electronic device may be a server or a terminal device.

As shown in FIG. 1, the electronic device includes a processor 100 and a memory 101. The memory 101 has stored therein machine-executable instructions that can be executed by the processor 100, the machine-executable instructions, when executed by the processor 100, cause the processor 100 to implement the above-mentioned method for audio control.

Furthermore, the electronic device in FIG. 1 further includes a bus 102 and a communication interface 103, and the processor 100, the communication interface 103 and the memory 101 are connected via the bus 102.

The memory 101 may include a high-speed random-access memory (RAM), or a non-volatile memory (non-volatile memory), for example, at least one disk storage. The communication connection between the system network element and at least one other network element is realized through at least one communication interface 103 (which may be wired or wireless), and the Internet, wide area network, local area network, metropolitan area network, etc. may be used. The bus 102 may be an Industry Standard Architecture (ISA) bus, a Peripheral Component Interconnect (PCI) bus, or an Extended Industry Standard Architecture (EISA) bus, etc. The bus may be categorized as an address bus, a data bus, a control bus, etc. For ease of representation, only one bidirectional arrow is used in FIG. 1, but it does not mean that there is only one bus or one type of bus.

The processor 100 may be an integrated circuit with signal processing capability. In the implementation process, the various steps of the above method may be implemented by an integrated logic circuit of the processor 100 in hardware form or implemented by instructions in the form of software in the processor 100. The processor 100 may be a general-purpose processor, including a central processing unit (CPU), a network processor (NP), etc. The processor 100 may also be a digital signal processor (DSP), an application specific integrated circuit (ASIC), a field programmable gate array (FPGA) or any other programmable logic device, discrete gate or transistor logic device, discrete hardware component. Various methods, steps and logic block diagrams in the embodiments of the present disclosure may be implemented or carried out. The general processor may be a micro-processor or any conventional processor, etc. The steps of the method in the embodiments of the present disclosure may be directly implemented by a hardware decoding processor, or implemented by a combination of hardware and software modules in the decoding processor. The software modules may be located in a storage medium well-known in the art, such as a random-access memory, a flash memory, a read-only memory, a programmable read-only memory, or an electrically erasable programmable memory, a register. The storage medium is located in the memory 101, and the processor 100 reads the information in the memory 101 and finishes the following steps in combination with its hardware: performing sound effect testing on a target space based on a specified measurement signal, and obtaining environmental response information, where the environmental response information includes impulse response information and post-separation impulse response information; analyzing the environmental response information, and obtaining acoustic characteristics information of the target space; performing compensation processing on audio to be processed based on the acoustic characteristic information, and obtaining adjusted audio; adjusting gains of a plurality of channels corresponding to the adjusted audio, and obtaining re-adjusted audio; and performing multi-channel collaborative optimization processing on the re-adjusted audio, and obtaining audio with a target effect.

In an implementation, performing sound effect testing on the target space based on the specified measurement signal and obtaining the environmental response information includes: collecting, by using a preset collection device array, response information of a plurality of measurement points in the target space for the specified measurement signal, where the plurality of measurement points forms a measurement grid; performing information extraction on the response information of the plurality of measurement points, and obtaining impulse response information corresponding to each of the plurality of measurement points; separating the impulse response information corresponding to each of the plurality of measurement points, and obtaining a direct sound, an early reflection and a reverberation tail corresponding to each of the plurality of measurement points; and determining the impulse response information, the direct sound, the early reflection, and the reverberation tail corresponding to each of the plurality of measurement points as the environmental response information of the target space.

In an implementation, analyzing the environmental response information and obtaining the acoustic characteristics information of the target space includes: performing spectrum analysis on the impulse response information in the environmental response information, and obtaining a spectrum analysis result, where the spectrum analysis result includes a frequency response curve and a power spectral density; identifying, based on the power spectral density, environmental mode parameters of the target space, where the environmental mode parameters include a modal density and a modal overlap degree; calculating, based on the reverberation tails corresponding to each of the plurality of measurement points, a reverberation time corresponding to each of the plurality of measurement points; analyzing the early reflection and the direct sound corresponding to each of the plurality of measurement points, and obtaining an early reflection analysis result corresponding to each of the plurality of measurement points; and determining the spectrum analysis result, the environmental mode parameters of the target space, the reverberation time and the early reflection analysis result corresponding to each of the plurality of measurement points as the acoustic characteristic information of the target space.

In an implementation, performing compensation processing on the audio to be processed based on the acoustic characteristic information and obtaining the adjusted audio includes: generating an adaptive equalization model based on the frequency response curve in the acoustic characteristic information, where the adaptive equalization model is used for band-limited adaptive filtering; generating an adaptive modal control model, where the adaptive modal control model is used for an environmental adaptive-dynamic control mode; performing optimization processing on the early reflection analysis result in the acoustic characteristic information, and obtaining optimized early reflection information; adjusting the reverberation time in the acoustic characteristic information, and obtaining adjusted reverberation time; and performing adjustment processing on the audio to be processed through the adaptive equalization model, the adaptive modal control model, the optimized early reflection information and the adjusted reverberation times, and obtaining the adjusted audio.

In an implementation, generating the adaptive equalization model based on the frequency response curve in the acoustic characteristic information includes: adjusting the frequency response curve in the acoustic characteristic information by using a specified standard curve, and obtaining a target response curve; generating a parametric equalization model based on the target response curve; and adjusting a parameter of the parametric equalization model by using a preset adaptive algorithm, and obtaining the adaptive equalization model.

In an implementation, generating the adaptive modal control model includes: identifying a mode type of the target space; setting a filter corresponding to the mode type; and adjusting a parameter of the filter corresponding to the mode type, and obtaining the adaptive modal control model.

In an implementation, performing optimization processing on the early reflection analysis result in the acoustic characteristic information and obtaining the optimized early reflection information includes: calculating, based on the early reflection analysis result in the acoustic characteristic information, a delay time and an energy attenuation value for each early reflection path; performing time alignment processing on the early reflection based on the delay time, and performing phase correction on the impulse response information, and obtaining processed information; obtaining a target sound field characteristic, where the target sound field characteristic is an ideal environmental acoustic characteristic; adjusting, based on the energy attenuation value and the target sound field characteristic, reflection energy in the early reflection analysis result, and obtaining adjusted reflection energy; and determining the processed information and the adjusted reflection energy as the optimized early reflection information.

In an implementation, adjusting the reverberation time in the acoustic characteristic information and obtaining the adjusted reverberation time includes: determining an ideal reverberation time according to a scenario type; generating a multi-channel feedback delay network, where the multi-channel feedback delay network is used to simulate natural reverberation; and adjusting, based on the ideal reverberation time and the multi-channel feedback delay network, the reverberation time in the acoustic characteristic information, and obtaining the adjusted reverberation time.

In an implementation, adjusting the gains of the plurality of channels corresponding to the adjusted audio and obtaining the re-adjusted audio includes: obtaining noise prediction information of the target space, where the noise prediction information is used to indicate noise levels at different time periods; adjusting, based on the noise prediction information, compression ratios and compression thresholds of the plurality of channels corresponding to the adjusted audio, and obtaining a plurality of adjusted channels; and performing, based on the plurality of adjusted channels, masking-based gain control on the adjusted audio, and obtaining the re-adjusted audio.

In an implementation, performing multi-channel collaborative optimization processing on the re-adjusted audio and obtaining the audio with the target effect includes: analyzing a channel cross-influence characteristic between the plurality of adjusted channels; performing phase compensation and amplitude compensation on the re-adjusted audio based on the channel cross-influence characteristic, and obtaining an equalized sound effect; and processing the equalized sound effect based on a preset adaptive cross-cancellation algorithm, and obtaining the audio with the target effect.

In an implementation, the method further includes: identifying a current audio use scenario, and automatically matching a control strategy corresponding to the audio use scenario, where the control strategy includes content of the acoustic characteristic information, compensation processing content and a compensation processing procedure.

In an implementation, after performing multi-channel collaborative optimization processing on the re-adjusted audio and obtaining the audio with the target effect, the method further includes: obtaining analysis data, and performing, based on the analysis data, a mechanism update and/or a strategy optimization for an audio control manner, where the analysis data includes performance test data and user evaluation data.

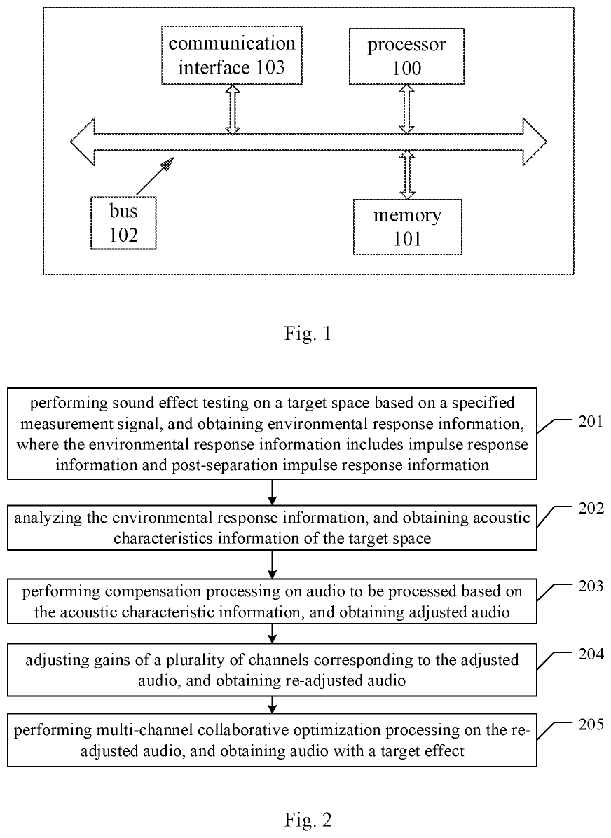

For ease of understanding, the specific process of the present disclosure is described below. As shown in FIG. 2, a computer-implemented method for audio control according to embodiments of the present disclosure includes the following steps.

Step 201, performing sound effect testing on a target space based on a specified measurement signal, and obtaining environmental response information, where the environmental response information includes impulse response information and post-separation impulse response information.

The specified measurement signal may be understood as a preset audio signal used to evaluate a performance of an audio system or an environmental acoustic characteristic. The specified measurement signal is a measurement signal that possesses, but is not limited to, controllability, stability and analyzability. The impulse response information can be understood as the extracted target response information, which is the response information fed back from the target space after the sound effect test based on the specified measurement signal and recorded by a specified recording device. The post-separation impulse response information may be understood as information processed by a preset window separation function (or a preset window separation algorithm). By way of non-limiting example, the target space may be a room where the audio to be processed is played.

By way of non-limiting example, the specified measurement signal is determined, and the specified measurement signal is transmitted into the target space by a preconfigured transmitting device. Response information fed back from a specific position in the target space is collected by a preconfigured recording device based on the specified measurement signal, and extraction is performed on the response information to obtain impulse response information. Separation processing is performed on the impulse response information to obtain separated information, and the impulse response information and the separated information are is determined as the environmental response information.

Step 202, analyzing the environmental response information, and obtaining acoustic characteristics information of the target space.

By way of non-limiting example, at least one acoustic characteristic factor to be analyzed is determined, where the at least one acoustic characteristic factor is a key element of the spatial acoustic performance. Search is performed on a preset algorithm library by using a preset search algorithm based on the at least one acoustic characteristic factor, so as to obtain a target algorithm. The search algorithm is used to search for or find an algorithm corresponding to an optimal path in the preset algorithm library. For example, the search algorithm may be the Dijkstra's algorithm, the A-star (A*) algorithm, the Depth-First Search (DFS) or Breadth-First Search (BFS) algorithm. There are various algorithms (models) for analyzing the acoustic characteristic factor stored in the preset algorithm library, and the target algorithm includes algorithms corresponding to the acoustic characteristic factors, respectively. The environmental response information is processed by using the target algorithm to obtain the acoustic characteristic information of the target space. By matching the target algorithm based on at least one acoustic characteristic factor, the efficiency and accuracy of environmental response information analysis are improved, as are the accuracy and reliability of the acoustic characteristic information of the target space.

Step 203, performing compensation processing on audio to be processed based on the acoustic characteristic information, and obtaining adjusted audio.

The audio to be processed is audio information corresponding to a target use scenario, such as music appreciation, movie watching, and gaming.

By way of non-limiting example, a target compensation algorithm is determined based on the acoustic characteristic information. The target compensation algorithm is used to perform compensation processing on the audio to be processed, so as to obtain the adjusted audio. The target compensation algorithm includes, but is not limited to, an adaptive equalization algorithm, an environmental mode suppression algorithm (also known as an intelligent environmental adaptive processing algorithm, which is used to analyze environmental information of the target space in real time and dynamically adjust an audio parameter), an early reflection optimization algorithm, an automatic gain control algorithm, a wide dynamic range compression algorithm, an equalizer, a noise suppression algorithm and an echo cancellation algorithm.

Step 204, adjusting gains of a plurality of channels corresponding to the adjusted audio, and obtaining re-adjusted audio.

By way of non-limiting example, a gain adjustment strategy for each channel is determined. Specifically, content of the audio to be processed is obtained, and based on the content of the audio and the acoustic characteristics information, a gain adjustment strategy for each channel corresponding to the adjusted audio is determined. The gain adjustment strategy includes, but is not limited to, loudness matching, dynamic range control, spatial balance, spectral balance, and scene optimization. Based on the gain adjustment strategy for each channel, the gains of the plurality of channels corresponding to the adjusted audio are adjusted, so as to obtain the re-adjusted audio.

Step 205, performing multi-channel collaborative optimization processing on the re-adjusted audio, and obtaining audio with a target effect.

By way of non-limiting example, the multi-channel layout of the re-adjusted audio is determined; and channel analysis, adaptive filtering and multi-channel complementary equalization are performed on the re-adjusted audio based on the multi-channel layout, so as to obtain the audio with the target effect.

By way of non-limiting example, after performing channel analysis, adaptive filtering, and multi-channel complementary equalization on the re-adjusted audio, the following may be implemented: performing enhance processing on the re-adjusted audio to obtain enhanced audio; performing test on the enhanced audio, performing evaluation on a test result, and determining the enhanced audio as the audio for the target effect in a case that an evaluation result meets a preset condition. Through testing and evaluation, the reliability of the audio with the target effect may be improved, thereby providing a high-quality audio experience.

In the present disclosure, by performing compensation processing, gain control processing and multi-channel collaborative optimization processing on the acoustic characteristic information obtained from analyzing the environmental response information, which is obtained from performing sound effect testing based on a specified measurement signal, precise compensation for acoustic defects in the target space is achieved, a crosstalk between channels is effectively addressed, the localization and spatial sense of a sound image are significantly enhanced, and thereby an overall listening experience for the audio is greatly improved, continuously optimizing the audio output.

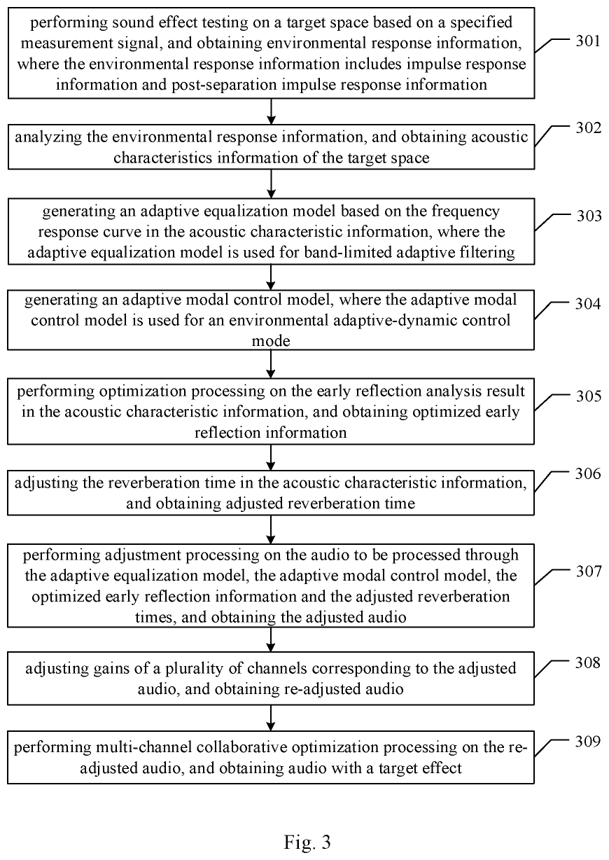

As shown in FIG. 3, the computer-implemented method for audio control according to embodiments of the present disclosure includes the following steps.

Step 301, performing sound effect testing on a target space based on a specified measurement signal, and obtaining environmental response information, where the environmental response information includes impulse response information and post-separation impulse response information.

In an implementation, when performing sound effect testing on the target space based on the specified measurement signal and obtaining the environmental response information, the following may be implemented: collecting, by using a preset collection device array, response information of a plurality of measurement points in the target space for the specified measurement signal, where the plurality of measurement points forms a measurement grid; performing information extraction on the response information of the plurality of measurement points, and obtaining impulse response information corresponding to each of the plurality of measurement points; separating the impulse response information corresponding to each of the plurality of measurement points, and obtaining a direct sound, an early reflection and a reverberation tail corresponding to each of the plurality of measurement points; and determining the impulse response information, the direct sound, the early reflection, and the reverberation tail corresponding to each of the plurality of measurement points as the environmental response information of the target space.

By way of non-limiting example, the specified measurement signal is a wideband sweep signal capable of covering an entire frequency band from 20 Hz to 20 kHz. Before collecting the response information of multiple measurement points in the target space for the specified measurement signal through the preset collection device array, the specified measurement signal may be generated by a preset exponential sweep signal algorithm. The exponential sweep signal algorithm may be as follows: x(t)=sin[2πf₁T(e^{\hat{ }(t/L))}−1/ln(f₂/f₁)], where f₁ is a starting frequency, f₂ is an ending frequency, T is a sweep time, and L=T/ln(f₂/f₁). Through generating the specified measurement signal through the exponential sweep signal algorithm, a signal-to-noise ratio and a time resolution of the specified measurement signal are improved.

In an implementation, before collecting the response information of multiple measurement points in the target space for the specified measurement signal through the preset collection device array, environmental characteristics of the target space may be obtained. The environmental characteristics include, but are not limited to, a geometric structure and an acoustic feature. Next, based on the environmental characteristics of the target space, the distribution of multiple measurement points in different locations within a listening area of the target space is determined. These multiple measurement points form a three-dimensional measurement grid in X, Y and Z axes, covering multiple spatial locations in the target space to facilitate comprehensive acoustic data collection. Specifically, the following may be implemented: obtaining environmental characteristics of the target space, including but not limited to a geometric structure (e.g., a spatial shape, a spatial size), an environmental type, an environmental purpose, and an acoustic feature; matching measurement point layout information corresponding to the environmental characteristics from a preset database, where measurement point layout information includes, but is not limited to, a key location, a quantity and a combined shape of the measurement points; and determining different locations of multiple measurement points in the listening area of the target space based on the measurement point layout information. By determining multiple measurement points in the target space based on the measurement point layout information, the reliability of the multiple measurement points is improved, which is beneficial for measuring spaces in various environments and thus helps improve the accuracy control of the audio with the target effect.

By way of non-limiting example, the preset collection device array may be a high-precision measurement-grade microphone, so as to ensure measurement accuracy. When collecting the response information of the plurality of measurement points in the target space for the specified measurement signal by using the preset collection device array, the following may be implemented: obtaining response information corresponding to each measurement point in the target space based on a preset measurement quantity, and obtaining collection information corresponding to the preset measurement quantity for each measurement point; and calculating an arithmetic mean of the collection information corresponding to the preset measurement quantity for each measurement point, and obtaining the response information of the plurality of measurement points in the target space to the specified measurement signal. Through calculating the arithmetic mean of the collection information corresponding to the preset measurement quantity for each measurement point, the signal-to-noise ratio of the response information is improved.

In an implementation, when performing information extraction on the response information of the plurality of measurement points, and obtaining impulse response information corresponding to each of the plurality of measurement points, the following may be implemented: performing signal extraction on the response information of the plurality of measurement points by using a preset frequency domain analysis algorithm, to obtain the impulse response information corresponding to each measurement point. The frequency domain analysis algorithm may be as follows: h(t)=IFFT(H(ω)), H(ω)=Y(ω)/X(ω), where H(ω) is a transfer function (a frequency response function) corresponding to each measurement point, Y(ω) is the response information of each measurement point, X(ω) is the specified measurement signal, and h(t) is the impulse response information corresponding to each measurement point.

In an implementation, a preset time window algorithm may be used to separate the impulse response information corresponding to multiple measurement points, so as to obtain a direct sound, an early reflection and a reverberation tail corresponding to each measurement point. The time window algorithm may be a sliding window algorithm, a window function (e.g., a Hanning window), or an overlapping window algorithm, so as to reduce spectral leakage and improve the accuracy of frequency domain analysis.

When obtaining the impulse response information, the direct sound, the early reflections, and the reverberant tails of multiple measurement points in the target space in the form of a measurement grid, based on a specified measurement signal, a measurement process is simplified, the accuracy of environmental response information analysis is improved, and the propagation effect and listening quality of audio are enhanced.

In an implementation, before performing the sound test on the target space based on the specified measurement signal and obtaining the environmental response information, the following may be implemented: identifying a current audio use scenario, and automatically matching a control strategy corresponding to the audio use scenario, where the control strategy includes content of the acoustic characteristic information, compensation processing content and a compensation processing procedure.

In an implementation, the current audio use scenario may be identified through a pre-set machine learning algorithm. The machine learning algorithm may be a support vector machine (SVM) classification algorithm, as detailed below: f(x)=sign(Σ(αᵢ*yᵢ*K(xᵢ, x))+b), where αᵢ is a Lagrange multiplier, yᵢ is a class label, K is a kernel function, xᵢ is an input audio to be processed, and b is a bias term.

By way of non-limiting example, audio use scenarios may include music appreciation, movie watching and gaming. By adjusting the parameters and algorithms of an audio processing system according to the audio use scenario, the audio experience in each scenario can be optimized, so as to suit the needs and preferences of different users.

The control strategy may be understood as follows. Sound effect testing is performed on the target space based on the specified measurement signal, and the environmental response information is obtained, where the environmental response information includes impulse response information and post-separation impulse response information. The environmental response information is analyzed, and acoustic characteristics information of the target space is obtained. Next, compensation processing is performed on audio to be processed based on the acoustic characteristic information, and the adjusted audio is obtained. The gains of the plurality of channels corresponding to the adjusted audio are, and the re-adjusted audio is obtained. Finally, multi-channel collaborative optimization processing is performed on the re-adjusted audio, and the audio with the target effect is obtained.

By way of non-limiting example, the control strategy corresponding to the audio use scenario may be automatically matched as follows. (1) When the audio use scenario is music (characteristics: high-fidelity sound quality, strong low-frequency response, clear mid-high frequencies, good spatial sense and stereo effect of audio), the corresponding control strategy includes a room acoustic compensation strategy (adjusting a frequency response to reduce standing waves and pattern interference in the room, making the low frequencies more balanced), a reverberation time control strategy (setting an appropriate reverberation time to preserve the natural continuity of the music without causing too much reverberation tail) and a dynamic range processing strategy (using slight dynamic range compression during the music appreciation to preserve details and dynamic changes of the music). (2) When the audio use scenario is a movie (characteristics: clear dialogue, rich sound effects, and appropriate low frequencies to enhance immersion, and more sensitive to the spatial positioning and effects of sound, such as surround sound and foreground sound effects), the corresponding control strategy includes a room acoustic compensation strategy (optimizing frequency response and phase to ensure clear dialogue and good positioning of sound effects), a reverberation time control strategy (setting a longer reverberation time to simulate the surround sound effect of the movie, while controlling low frequency reverberation) and a dynamic range processing strategy (using moderate dynamic range compression to balance the dynamic range of dialogue and sound effects and avoid sound being too abrupt).

For example, the audio system includes a touchscreen interface that allows users to visually view and adjust the sound field using a 3D room model. By analyzing audio content and user operations, the audio system can distinguish between the music, the movie, and the game modes with 95% accuracy and automatically apply corresponding optimization settings. The audio system observed that users often increase low-frequency output when watching action movies, so it automatically boosts the low-frequency response by 2 dB when action scenes are detected.

Intelligent dynamic optimization is achieved through intelligent scenario recognition and control strategy matching.

In an implementation, the computer-implemented method for audio control further includes: displaying, by using a pre-set three-dimensional (3D) spatial acoustic visualization tool, a sound field distribution of the audio to be processed and/or a sound field distribution of the audio with the target effect, as well as a comparison result, where the comparison result is a result of comparing a real-time frequency response curve with an optimized effect. Through the intuitive 3D visualization provided by the three-dimensional spatial acoustic visualization tool, high performance is ensured while also guaranteeing ease of use and scalability, thereby greatly improving the user experience.

In an implementation, the computer-implemented method for audio control further includes: obtaining adjustment data in response to a touch operation on the three-dimensional spatial acoustic visualization tool, and performing a sound field adjustment on the audio to be processed and/or the audio with the target effect based on the adjustment data. The intuitive control offered by the three-dimensional spatial acoustic visualization tool ensures high performance while also providing ease of use and scalability, significantly enhancing the user experience.

In an implementation, the computer-implemented method for audio control further includes: obtaining adjustment operation data based on a user interface in response to an optimization instruction; and performing parameter optimization based on the adjustment operation data by using a preset reinforcement learning algorithm. By way of non-limiting example, the reinforcement learning algorithm may be specifically as follows: Q(s, a)←Q(s, a)+α*[r+γ*maxₐ, Q(s′, a′)−Q(s, a)], where s is a state, a is an action, α is a learning rate, r is a reward, and γ is a discount factor. By performing parameter optimization based on the adjustment operation data using the preset reinforcement learning algorithm, system parameters can be continuously optimized to meet user preferences, thereby achieving user preference learning and personalized dynamic optimization.

Step 302, analyzing the environmental response information, and obtaining acoustic characteristics information of the target space.

In an implementation, when analyzing the environmental response information and obtaining the acoustic characteristics information of the target space, the following may be implemented: performing spectrum analysis on the impulse response information in the environmental response information, and obtaining a spectrum analysis result, where the spectrum analysis result includes a frequency response curve and a power spectral density; identifying, based on the power spectral density, environmental mode parameters of the target space, where the environmental mode parameters include a modal density and a modal overlap degree; calculating, based on the reverberation tails corresponding to each of the plurality of measurement points, a reverberation time corresponding to each of the plurality of measurement points; analyzing the early reflection and the direct sound corresponding to each of the plurality of measurement points, and obtaining an early reflection analysis result corresponding to each of the plurality of measurement points; and determining the spectrum analysis result, the environmental mode parameters of the target space, the reverberation time and the early reflection analysis result corresponding to each of the plurality of measurement points as the acoustic characteristic information of the target space.

In an implementation, when performing spectrum analysis on the impulse response information in the environmental response information, and obtaining the spectrum analysis result, the following may be implemented: calculating, based on the impulse response information of each measurement point in the environmental response information, a frequency response curve for each measurement point, where the frequency response curve is used to represent the response of the audio system at different frequencies; performing smooth processing on the frequency response curve, and obtaining a smoothed frequency response curve; calculating the power spectral density based on the smoothed frequency response curve (by normalizing the square of an amplitude of the smoothed frequency response curve); and determining the frequency response curve and the power spectral density as the spectral analysis result.

By way of non-limiting example, the frequency response curve may be smoothed using a one-third octave band smoothing algorithm to obtain the smoothed frequency response curve, thereby reducing the impact of small fluctuations. Based on a preset power spectral density estimation formula, the smoothed frequency response curve is calculated to obtain the power spectral density. The power spectral density is used to indicate a distribution of signal power of the environmental response information at different frequencies. The power spectral density estimation formula is as follows: PSD(ω)=|FFT(h(t))|²/N, where PSD(ω) is the power spectral density, h(t) is the smoothed frequency response curve, and N is a FFT length.

In an implementation, the modal density is used to indicate a quantity of modes per unit frequency range, and the modal overlap is used to indicate a degree of overlap between different modes in frequency. When identifying the environmental mode parameters of the target space based on the power spectral density, the following may be implemented: performing statistical analysis on the power spectral density, and obtaining a peak value of the power spectral density, where the peak value of the power spectral density corresponds to a dominant mode frequency; calculating a quantity of modes within a specific frequency range based on the peak value of the power spectral density, where the quantity of modes within the specific frequency range is related to geometric dimensions of the target space; calculating the modal density based on the quantity of modes within the specific frequency range and a preset calculation formula, where the preset calculation formula may be as follows: D(f)=N/Δf, N=(4πV/c³)*f², where D(f) is the modal density, N is the quantity of modes within the specific frequency range, and Δf is a width of the frequency range, Vis a volume of the target space, c is the speed of sound, and f is the frequency; analyzing frequency response information of the target space to determine a bandwidth of each mode of the target space; plotting, based on the bandwidth of each mode of the target space, frequency ranges of different modes of the target space on a spectrogram corresponding to the impulse response information, and obtaining a target spectrogram; calculating overlapping regions of different modes of the target space based on the target spectrum; calculating overlapping areas of different modes on the target spectrogram and a total spectral area of all modes based on the overlapping regions of different modes; calculating the modal overlap degree based on the overlapping areas of different modes on the target spectrogram and the total spectral area of all modes; where, specifically, the modal overlap degree may be calculated by dividing the overlapping areas of different modes on the target spectrogram by the total spectral area of all modes; and determining the modal density and modal overlap degree as the environmental mode parameters of the target space. When calculating such environmental mode parameters as the modal density and modal overlap degree, it helps to gain a preliminary understanding of an environmental mode of the target space, reflecting the degree of interaction between modes and the complexity of the dynamic response of the audio system, thus contributing to a more accurate analysis of the acoustic characteristics of the target space.

In an implementation, when calculating, based on the reverberation tails corresponding to each of the plurality of measurement points, the reverberation time corresponding to each of the plurality of measurement points, the following may be implemented: calculating the reverberation tails of the plurality of measurement points by using a preset Schroeder integration algorithm, and obtaining the reverberation time corresponding to each measurement point. The Schroeder integration algorithm is as follows: EDC(t)=∫[t→∞]h²(τ)dτ, RT60=time when EDC(t) drops by 60 dB, where EDC(t) is an energy decay curve, t is a lower limit of integration time, h²(τ) is the impulse response information, dτ is a small increment of an integral variable τ, and RT60 is the reverberation time corresponding to each measurement point. When calculating the reverberation time by frequency band, the decay characteristics at different frequencies are effectively analyzed, thereby improving the reliability of acoustic characteristic information.

In an implementation, when analyzing the early reflection and the direct sound corresponding to each of the plurality of measurement points, and obtaining the early reflection analysis result corresponding to each of the plurality of measurement points, the following may be implemented: detecting, by using a preset threshold detection algorithm, the early reflection and the direct sound corresponding to each measurement point, and obtaining a reflection peak value and a direct sound peak value corresponding to each measurement point, where the reflection peak value is a peak value of the early reflection and the direct sound peak value is a peak value of the direct sound; calculating a time delay of the early reflection relative to the direct sound based on a distance difference between the reflection peak value and the direct sound peak value corresponding to each measurement point; calculating the total sound energy (including the direct sound and all reflected sound) during an entire measurement period; calculating the direct sound energy based on the direct sound peak value; calculating the total reflection energy, where, specifically, for each reflection peak value, a window around a center time of each peak is determined, and the sum of squares of the signal in each window is calculated to obtain the energy of a single reflection peak, and energies of all reflection peaks are added together to obtain the total reflection energy; dividing the direct sound energy by the total reflection energy to obtain a first energy ratio, dividing the total reflection energy by the total sound energy to obtain a second energy ratio, and determining the first energy ratio and the second energy ratio as an energy ratio of the early reflection to the direct sound; and determining the time delay of the early reflection relative to the direct sound and the energy ratio of the early reflection to the direct sound corresponding to each measurement point as the early reflection analysis result corresponding to each measurement point. By calculating the time delay of the early reflection relative to the direct sound and the energy ratio of early reflection to the direct sound corresponding to each measurement point, the efficiency and accuracy of the early reflection analysis result are improved, which can effectively improve the spatial sense of audio and enhance the listener's immersion.

By analyzing the environmental response information, the acoustic characteristic information including the spectral analysis result, the environmental mode parameters of the target space, and the reverberation time and the early reflection analysis result corresponding to each measurement point is obtained. This improves the accuracy of acoustic characteristic analysis of the target space, helps to effectively overcome the negative impact of target space acoustics on sound quality, and can effectively adapt to the unique acoustic environment of different spaces.

Step 303, generating an adaptive equalization model based on the frequency response curve in the acoustic characteristic information, where the adaptive equalization model is used for band-limited adaptive filtering.

In an implementation, when generating the adaptive equalization model based on the frequency response curve in the acoustic characteristic information, the following may be implemented: adjusting the frequency response curve in the acoustic characteristic information by using a specified standard curve, and obtaining a target response curve; generating a parametric equalization model based on the target response curve; and adjusting a parameter of the parametric equalization model by using a preset adaptive algorithm, and obtaining the adaptive equalization model.

The preset standard curve may be understood as a standard or reference curve in the industry that helps design and calibrate the audio system to achieve a more natural or specific listening effect. It may also be understood as an idealized frequency response curve with flatness, bandwidth coverage, phase consistency and compliance with industry standards, such as a Harman target curve, a diffuse field equalization (DFE) curve, an equal loudness contour and an audio engineering society (AES) standard curve.

By way of non-limiting example, before adjusting the reverberation time in the acoustic characteristic information, and obtaining adjusted reverberation time, the following may be implemented: obtaining a use scenario and an adjustment target of the audio to be processed; and determining, based on the use scenario and the adjustment target, a corresponding standard curve to obtain the specified standard curve. When adjusting the frequency response curve in the acoustic characteristic information using the specified standard curve to obtain the target response curve, the following may be implemented: comparing and analyzing the specified standard curve and the frequency response curve in the acoustic characteristic information to obtain a difference; and adjusting the frequency response curve in the acoustic characteristic information to obtain the target response curve by using a preset calibration tool based on the difference. Adjusting the frequency response curve in the acoustic characteristic information can take into account the diffuse sound field response at a listening position.

In an implementation, when generating the parametric equalization model based on the target response curve, the parametric equalization model may be generated using the target response curve and an infinite impulse response (IIR) filter bank in a second-order filter cascade structure. The parametric equalization model may be implemented using the following algorithm: H(s)=(s²+A*ω₀ /Q*s+ω₀²)/(s²+ω₀/Q*s+ω₀²), where s is a complex frequency domain variable, s² reflects the influence of the system on a second derivative of a time domain signal, A is the gain, ω₀ is the center frequency in the target response curve, and Q is the quality factor. By using the IIR filter bank, accurate frequency response correction is achieved, and by using a second-order filter cascade structure, the smoothness of the phase response is ensured.

By way of non-limiting example, the adaptive algorithm may be a Least Mean Squares (LMS) algorithm, which is as follows: W(k+1)=W(k)+μ*X(k)*E(k), where W(k) is a filter coefficient, μ is a step size, X(k) is the frequency response corresponding to the target response curve, and E(k) is an error signal. By adjusting the parameters of the parametric equalization model using the LMS algorithm, bandwidth-limited adaptive filtering is achieved, thereby avoiding overcorrection.

By adjusting the frequency response curve in the acoustic characteristic information using the specified standard curve, and by adjusting the parameters of the parametric equalization model using the preset adaptive algorithm, the reliability and accuracy of the adaptive equalization model are improved, which helps to output higher quality audio effects and meet the usage needs of various scenarios (various complex environments).

Step 304, generating an adaptive modal control model, where the adaptive modal control model is used for an environmental adaptive-dynamic control mode.

In an implementation, when generating the adaptive modal control model, the following may be implemented: identifying a mode type of the target space; setting a filter corresponding to the mode type; and adjusting a parameter of the filter corresponding to the mode type, and obtaining the adaptive modal control model.

In an implementation, when identifying the mode type of the target space, the following may be implemented: performing calculation by using a preset mode frequency algorithm and obtaining a calculation result, where the mode frequency algorithm is as follows: f_{nx,ny,nz}=(c/2)*\sqrt{(nx/Lx)²+(ny/Ly)²+(nz/Lz)²}, where c is the speed of sound, nx, ny and nz are mode ordinal numbers, and Lx, Ly and Lz are room dimensions; and determining, based on the calculation result, the mode type of the target space, including an axial mode, a tangential mode, and an oblique mode. When identifying the model type of the target space, detailed information for subsequent suppression and optimization is provided. By way of non-limiting example, when the calculation result f nx, ny, nz includes only one non-zero mode ordinal (f_{nx,0,0}, f_{0,ny,0}, f_{0,0,nz}), the mode type of the target space is the axial mode; when the calculation result f_{nx,ny,nz} includes two non-zero mode ordinals (f_{nx,ny,0}, f_{nx,0,nz}, f_{0,ny,nz}), the mode type of the target space is the tangential mode; and when the calculation result f_{nx,ny,nz} includes three non-zero mode ordinals, the mode type of the target space is the oblique mode.

In an implementation, when setting the filter corresponding to the mode type, narrowband notch filters may be set for the axial mode, tangential mode and oblique mode of the mode type, respectively. The narrowband notch filter may be implemented as follows: H(z)=(1−2r*cosω₀*z⁻¹+r²*z⁻²)/(1−2*cosω₀*z⁻¹+z⁻²), where r is a control bandwidth, ω₀ is the center frequency, and z is a complex variable in the Z-transform, representing the frequency domain characteristics of a discrete-time system. The quality factor and depth of each narrowband notch filter are adjusted to achieve the best suppression effect.

In an implementation, when adjusting the parameter of the filter corresponding to the mode type and obtaining the adaptive modal control model, the parameter of the filter corresponding to the mode type may be adjusted using a recursive least squares (RLS) algorithm to obtain the adaptive modal control model. The recursive least squares (RLS) algorithm is as follows: K(n)=[λ⁻¹*P(n−1)*x(n)]/(1+λ⁻¹*xΛT(n)*P(n−1)*x(n)), e(n)=d(n)−wΛT(n)*x(n), w(n)=w(n−1)+K(n)*e(n), P(n)=λ⁻¹*P(n−1)−λ⁻¹*K(n)*xΛT(n)*P(n−1), where K(n) is a gain vector, which controls a magnitude of a weight update. λ is a forgetting factor, which controls the influence of historical data on the current iteration. P(n) is an error covariance matrix, which reflects the filter's error and uncertainty. x(n) is an input signal, which is a signal entering the filter. T(n) represents a transpose of vector x at time n. e(n) is an error signal, which represents a difference between a desired signal and a filter output. d(n) is the desired signal, which is an ideal value that the system expects the filter to output. w(n) is a filter weight, determining how the filter processes the input signal. Using the recursive least squares (RLS) algorithm, it can handle low-frequency response fluctuations under environmental changes, especially addressing low-frequency resonance problems caused by changes in spatial state (such as opening doors or moving furniture). It allows for more refined and faster real-time dynamic adjustments to the low-frequency spatial mode, real-time monitoring of low-frequency response changes, and adaptation to changes in the state of the target space.

By setting the corresponding filter according to the mode type of the target space and performing adaptive modal control on the filter, it is able to cope with low-frequency response fluctuations under environmental changes, make more precise and faster real-time dynamic adjustments to the low-frequency spatial mode, improve the flexibility of audio control, and maintain the flatness of the low-frequency response.

Step 305, performing optimization processing on the early reflection analysis result in the acoustic characteristic information, and obtaining optimized early reflection information.

In an implementation, when performing optimization processing on the early reflection analysis result in the acoustic characteristic information and obtaining the optimized early reflection information, the following may be implemented: calculating, based on the early reflection analysis result in the acoustic characteristic information, a delay time and an energy attenuation value for each early reflection path; performing time alignment processing on the early reflection based on the delay time, and performing phase correction on the impulse response information, and obtaining processed information; obtaining a target sound field characteristic, where the target sound field characteristic is an ideal environmental acoustic characteristic; adjusting, based on the energy attenuation value and the target sound field characteristic, reflection energy in the early reflection analysis result, and obtaining adjusted reflection energy; and determining the processed information and the adjusted reflection energy as the optimized early reflection information.

In an implementation, when calculating the delay time and an energy attenuation value for each early reflection path based on the early reflection analysis result in the acoustic characteristic information, the following may be implemented: generating an early reflection path model based on geometric information of the target space and the response information of multiple measurement points in the target space to the specified measurement signal; and calculating the delay time and energy attenuation value of each early reflection path using the early reflection path model. Specifically, ray tracing is performed using the early reflection path model, and a total ray path length of each early reflection path is calculated. The total ray path length of each early reflection path is divided by the speed of sound to obtain the delay time of each early reflection path. The product of absorption coefficients of all reflecting surfaces along the early reflection path is calculated, and the energy attenuation value of each early reflection path is calculated based on the product of the absorption coefficients of all reflecting surfaces along the early reflection path.

Specifically, a mirror position of a sound source for each reflecting surface is calculated by using the early reflection path model based on a mirror source algorithm, and the sound ray path is traced to achieve sound ray tracing. In particular, a structure of the target space (including a length, a width and a height of the target space and positions of the reflecting surfaces) is measured, a position of a sound source receiver is set, and a mirror sound source position of each reflecting surface is calculated. Next, a path from the mirror sound source to the receiver is traced, a path length, a time delay, and energy attenuation are calculated, a plurality of reflections are processed repeatedly based on a preset quantity of reflections, an impulse response of all reflected sounds is synthesized, a final room impulse response is generated, and convolved with the input signal (the impulse response information) to simulate the sound propagation effect in the target space.

In an implementation, performing time alignment processing on the early reflection based on the delay time, and performing phase correction on the impulse response information, and obtaining processed information, the following may be implemented: setting an finite impulse response (FIR) filter, where the FIR filter is as follows: h(n)=sin c(n−D)*w(n), where n is a time point in the delay time, D is a fractional delay representing a delay between early reflection sound and the direct sound, and w(n) is a window function; and performing time alignment processing on the early reflection using the FIR filter. When performing time alignment processing on the early reflection using the FIR filter, time alignment is achieved, enabling precise temporal synchronization between the early reflection and the direct sound. The impulse response information is extracted to obtain phase information; phase compensation is then performed based on the phase information using a preset all-pass filter to adjust the phase of corresponding frequency components. Through phase correction using the all-pass filter, sound image localization is optimized.

The target sound field characteristic is an ideal environmental acoustic characteristic. The target sound field characteristic is determined through reference standards, measurement, simulation or user requirements, and defines the ideal spatial acoustic characteristics, such as the reverberation time, energy distribution and diffusion of early reflections.

In an implementation, when adjusting the reflection energy in the early reflection analysis result based on the energy attenuation value and the target sound field characteristic and obtaining the adjusted reflection energy, the following may be implemented: adjusting, based on the energy attenuation value, the target sound field characteristic and a reflection energy optimization algorithm, the energy of each early reflection in the early reflection analysis result, to conform to the target energy, and obtaining the adjusted reflection energy. Specifically, the reflection energy optimization algorithm is as follows: minimize Σ(Eᵢ−Tᵢ)², subject to ΣEᵢ=Eₜₒₜₐₗ, where Eᵢ is energy of an i-th early reflection, Tᵢ is the target energy, and Eₜₒₜₐₗ is the total reflection energy. By adjusting the energy distribution of early reflections based on the energy attenuation value, the target sound field characteristic and the reflection energy optimization algorithm, controllable diffuse sound field and precise acoustic control in the target space are achieved, thereby optimizing the clarity, spatial sense and localization of the audio sound.

Through time alignment, phase correction, and reflection energy adjustment, a controllable diffuse sound field and precise acoustic control within the target space are achieved, optimizing the clarity, spatiality, and localization of audio sound, creating a natural diffuse sound field, and significantly improving the stability and spatiality of the sound image.

Step 306, adjusting the reverberation time in the acoustic characteristic information, and obtaining adjusted reverberation time.

In an implementation, when adjusting the reverberation time in the acoustic characteristic information and obtaining the adjusted reverberation time, the following may be implemented: determining an ideal reverberation time according to a scenario type; generating a multi-channel feedback delay network, where the multi-channel feedback delay network is used to simulate natural reverberation; and adjusting, based on the ideal reverberation time and the multi-channel feedback delay network, the reverberation time in the acoustic characteristic information, and obtaining the adjusted reverberation time.

By way of non-limiting example, the scenario type of the target space and the content type of the audio to be processed may be obtained. The ideal reverberation time is determined based on the scenario type of the target space, the content type of the audio to be processed, and a preset calculation function. The ideal reverberation time takes into account an optimal reverberation time ratio for different frequency bands. The specific calculation function is as follows: RTₒpt=k*(V/S)^{(1/3)}, where k is a coefficient determined based on a purpose (scenario type) of the target space, V is the volume of the target space, and S is the total surface area of the target space.

By way of non-limiting example, the generated multi-channel feedback delay network may as follows: y(n)=b^{T}*z(n)+d*x(n), z(n+1)=A*[D*z(n)+c*x(n)], where z(n) is a state vector of the feedback delay network, representing the signal input after one or more delay units; b, d, and c are gain coefficients; x(n) is the input signal, i.e., the data to be reverberated; A is a feedback matrix; and D is a delay matrix. By generating the multi-channel feedback delay network, frequency-dependent reverberation attenuation is achieved, thereby simulating real-world spatial characteristics.

In an implementation, when adjusting the reverberation time in the acoustic characteristic information based on the ideal reverberation time and the multi-channel feedback delay network and obtaining the adjusted reverberation time, the following may be implemented: performing real-time analysis on an actual reverberation characteristic of the target space, where the actual reverberation characteristic may be an actual reverberation time. The reverberation time may be estimated from the impulse response information using a preset reverberation time estimation algorithm, to obtain the actual reverberation characteristic of the target space. The reverberation time estimation algorithm is specifically as follows: RT60=argmax_RTp(h|RT), where h is the impulse response information and p(h|RT) is the probability of observing h at a given reverberation time RT. Next, the following may be implemented: adjusting, based on the ideal reverberation time and the actual reverberation characteristic of the target space, an artificial reverberation parameter of the multi-channel feedback delay network, to obtain the adjusted reverberation time. By adapting the reverberation parameters, natural reverberation is compensated for or enhanced.

By adjusting the reverberation time in the acoustic characteristic information based on the ideal reverberation time and the multi-channel feedback delay network, control of the reverberation time is achieved, natural reverberation and real spatial characteristics are simulated, and the fullness of the low-frequency response is maintained.

Step 307, performing adjustment processing on the audio to be processed through the adaptive equalization model, the adaptive modal control model, the optimized early reflection information and the adjusted reverberation times, and obtaining the adjusted audio.

By generating the adaptive equalization model, the adaptive modal control model, the early reflection optimization and adaptive control of reverberation time, the reliability and accuracy of the target acoustic characteristic information are improved. This helps to effectively overcome the negative impact of spatial acoustics on sound quality, enabling near-ideal sound reproduction to be achieved in various environments.

Step 308, adjusting gains of a plurality of channels corresponding to the adjusted audio, and obtaining re-adjusted audio.

In an implementation, when adjusting the gains of the plurality of channels corresponding to the adjusted audio and obtaining the re-adjusted audio, the following may be implemented: obtaining noise prediction information of the target space, where the noise prediction information is used to indicate noise levels at different time periods; adjusting, based on the noise prediction information, compression ratios and compression thresholds of the plurality of channels corresponding to the adjusted audio, and obtaining a plurality of adjusted channels; and performing, based on the plurality of adjusted channels, masking-based gain control on the adjusted audio, and obtaining the re-adjusted audio.

In an implementation, when the obtaining noise prediction information of the target space, the following may be implemented: identifying a background noise of the target space by using a preset long-time average spectrum algorithm, where the long-time average spectrum algorithm is as follows: LTAS(f)=(1/M)*Σ|Xₘ(f)|², M is a total quantity of frames, and Xₘ(f) is a short-time Fourier transform of a m-th frame; generating a noise model based on the background noise of the target space; and predicting a noise level at different time periods through the noise model to obtain noise prediction information of the target space.

In an implementation, the compression ratio is used to indicate a degree of compression of the input signal after it exceeds a threshold. It defines an input-output relationship of the signal when the signal exceeds a set threshold; the higher the compression ratio, the stronger the signal compression. A compression threshold is used to indicate a trigger point for dynamic range compression, and defines when the signal begins to be compressed. When adjusting the compression ratios and compression thresholds of the plurality of channels corresponding to the adjusted audio based on the noise prediction information and obtaining the plurality of adjusted channels, the following may be implemented: adjusting the compression ratios and compression thresholds of the plurality of channels corresponding to the adjusted audio using a preset multi-band dynamic range compression algorithm and the noise prediction information to obtain the plurality of adjusted channels. The multi-band dynamic range compression algorithm is as follows: y(n)=x(n)*G(n), G(n)=min(1,(T/|x(n)|)^{(1-1/R)}), where y(n) is an output signal after dynamic range compression, G(n) is a gain (or attenuation) coefficient of a dynamic range compressor, and used to control the signal amplitude, T is the compression threshold, |x(n)| is the signal amplitude, and R is the compression ratio. When the input signal amplitude |x(n)| exceeds the compression threshold T, the compressor starts working, reducing an increment of the input signal. When the input signal amplitude |x(n)| is less than or equal to the compression threshold T, it remains in its original state and no compression is performed. By using the preset multi-band dynamic range compression algorithm and the noise prediction information, the compression ratios and compression thresholds of the plurality of channels corresponding to the adjusted audio are adjusted. This controls the signal amplitude, keeping it within a reasonable range. It controls signals with large intensity variations, reducing their dynamic range, preventing signals from being too strong or too weak, and ensuring auditory comfort, which is especially important in situations with high spatial noise.

In an implementation, when performing masking-based gain control on the adjusted audio based on the plurality of adjusted channels and obtaining the re-adjusted audio, the following may be implemented: processing the adjusted audio based on the plurality of adjusted channels using a preset masking-based gain control algorithm, to obtain the re-adjusted audio. Specifically, the masking-based gain control algorithm is as follows: G_opt=argmax_G(SNR_perceptual (G)−α*|G−G_prev|), where SNR_perceptual (G) is a perceptual signal-to-noise ratio, α is a smoothing factor, G_prev is a gain of a previous frame, and G is a gain of a current frame. By processing the adjusted audio based on the plurality of adjusted channels using the preset masking-based gain control algorithm, automatic volume adjustment is achieved, thereby maintaining an appropriate signal-to-noise ratio, considering auditory masking effects, and optimizing the gain adjustment strategy.

When adjusting the compression ratios and compression thresholds of the plurality of channels corresponding to the adjusted audio based on the noise prediction information and obtaining a plurality of adjusted channels, and performing masking-based gain control on the adjusted audio based on the plurality of adjusted channels and obtaining the re-adjusted audio, multi-band compression is achieved, the spectral balance of the signal is protected, automatic volume adjustment is realized, an appropriate ratio of signal to noise is maintained, auditory masking effect is considered, and the gain adjustment strategy is optimized to ensure that the dynamic range of the audio is fully exhibited in a quiet environment, while avoiding overly harsh sound.

Step 309, performing multi-channel collaborative optimization processing on the re-adjusted audio, and obtaining audio with a target effect.

In an implementation, when performing multi-channel collaborative optimization processing on the re-adjusted audio and obtaining the audio with the target effect, the following may be implemented: analyzing a channel cross-influence characteristic between the plurality of adjusted channels; performing phase compensation and amplitude compensation on the re-adjusted audio based on the channel cross-influence characteristic, and obtaining an equalized sound effect; and processing the equalized sound effect based on a preset adaptive cross-cancellation algorithm, and obtaining the audio with the target effect.

In an implementation, when analyzing the channel cross-influence characteristic between the plurality of adjusted channels, the following may be implemented: measuring and analyzing acoustic coupling characteristics between the adjusted channels; generating a multi-channel interaction model based on the acoustic coupling characteristics; and analyzing channel crossover characteristics between the adjusted channels using the multi-channel interaction model and a multi-channel transfer function matrix. The multi-channel transfer function matrix is as follows: H=[H₁₁ H₁₂ . . . H_{1N}; H₂₁ H₂₂ . . . H_{2N}; . . . H_{N2} . . . H_{NN}], where Hᵢⱼ is a transfer function from a channel j to a position i.

In an implementation, when performing phase compensation and amplitude compensation on the re-adjusted audio based on the channel cross-influence characteristic and obtaining the equalized sound effect, the following may be implemented: generating a multi-channel joint equalizer based on the channel cross-influence characteristics. The multi-channel joint equalizer is as follows: Wₒpt=(H^{H}*H+λI)⁻¹*H^{H}, where H is a multi-channel transfer function matrix used in the channel cross-influence characteristic, λ is a regularization parameter, and I is an identity matrix, which is a matrix with diagonal elements of 1 and all other elements of 0, of the same size as H^{H}, and used for regularization. This formula is a weight calculation formula for a multi-channel Wiener filter. Through the multi-channel joint equalizer, phase compensation and amplitude compensation are performed on the re-adjusted audio to obtain equalized sound effects. By means of the multi-channel joint equalizer, phase and amplitude compensation between channels is achieved.

By way of non-limiting example, preset adaptive cross-cancellation algorithm may be: wᵢ(n+1)=wᵢ(n)+μ*e(n)*xᵢ(n)/(∥x(n)∥²+δ), where wᵢ(n) is a coefficient of an i-th filter, μ is a step size, e(n) is an error signal, xᵢ(n) is an input signal of each channel, and δ is a small positive number.

By performing phase compensation and amplitude compensation on the re-adjusted audio based on the channel cross-influence characteristic and processing the equalized sound effect based on the preset adaptive cross-cancellation algorithm, phase and amplitude compensation between channels is achieved, adaptive interference cancellation between channels is realized, negative interference between channels is minimized, comb filtering effects caused by crosstalk are reduced, and the clarity of dialogue in the audio as well as the separation of the front soundstage are improved.

In an implementation, after performing multi-channel collaborative optimization processing on the re-adjusted audio and obtaining the audio with the target effect, the following may be implemented: obtaining analysis data, and performing, based on the analysis data, a mechanism update and/or a strategy optimization for an audio control manner, where the analysis data includes performance test data and user evaluation data.

In an implementation, the performance test data includes, but is not limited to, a comprehensive acoustic parameter score. The performance test data may be obtained as follows: the comprehensive acoustic parameter score is calculated using an acoustic parameter comprehensive score algorithm, which is specifically as follows: Score=w1*F_flatness+w2*T_60_deviation+w3*C_50+w4*D_50+w5*LF, where w1, w2, w3, w4 and w5 are each a weighting coefficient, F_flatness is the frequency response flatness, T_60_deviation is a reverberation time deviation, C_50 is the clarity, D_50 is the definition, and LF is a lateral energy fraction.

In an implementation, the user evaluation data includes data from double-blind testing by professional audio engineers and ordinary users, as well as data on the overall sound quality performance of the system evaluated using a MUSHRA method.

In an implementation, the following may be implemented: performing cloud-based big-data self-optimization based on the analysis data, or performing remote firmware updates based on the analysis data, so as to improve the algorithm performance (mechanism updates and/or strategy optimization of the computer-implemented method for audio control). The cloud-based big-data self-optimization based on the analysis data may be realized through a swarm-intelligence-based parameter optimization algorithm. The swarm-intelligence-based parameter optimization algorithm is specifically as follows: pᵢ(t+1)=pᵢ(t)+vᵢ(t+1), vᵢ(t+1)=w*vᵢ(t)+c1*r1*(p_{best}−pᵢ(t))+c2*r2*(g_{best}−pᵢ(t)), where pᵢ(t+1) is a parameter vector, vᵢ(t+1) is a velocity vector, w, c1, c2 are each a control parameter, r1, r2 are random numbers, p_{best} is an individual optimal solution, pᵢ(t) is an individual optimization strategy, and g_{best} is a global optimal solution.

For example, when tested in 50 different home environments, the system improved the frequency response flatness to within ±3 dB in 90% of the scenarios, with a reverberation time control error of less than 10%. In MUSHRA tests, the system achieved an average score of 85 points, significantly higher than 65 points obtained in an unoptimized state. Through cloud-based data analysis, the system identified a general trend of weak low-frequency response in rooms with a volume of 56-60 m³, and accordingly updated the optimization strategy for that room type, further improving system performance.

Through rigorous performance testing and user evaluation, the system demonstrates outstanding performance and stability, while cloud-based big-data analysis and remote update mechanism allow it to continuously optimize performance and make customized adjustments for the specific needs of different types of spaces, greatly enhancing the adaptability and long-term value of the audio system.

In the computer-implemented method for audio control, by utilizing advanced spatial acoustic measurement techniques combined with artificial intelligence algorithms, the acoustic characteristic information (including frequency response, reverberation time, early reflections, room modes, etc.) of a room is accurately analyzed. It introduces adaptive filtering and intelligent equalization techniques, so as to automatically adjust audio parameters based on the analysis results, thereby achieving precise compensation for spatial acoustic defects. The innovative room mode suppression algorithm effectively improves low-frequency response. Furthermore, it integrates real-time adaptive technology that dynamically responds to changes in the room's acoustic characteristics (such as opening/closing doors and windows, people moving, etc.), continuously optimizing the audio output. The automatic adjustment function brings users significant sound quality improvement and ease of use. It effectively overcomes the negative impact of room acoustics on sound quality, enabling near-ideal sound reproduction to be achieved in different environments. The intelligent and automation characteristics allow users to obtain professional-grade audio adjustments without requiring specialized knowledge. By precisely controlling the frequency response and phase characteristics, the system significantly enhances sound clarity, localization and spaciousness. The dynamic adaptive function ensures that optimal sound quality is maintained even when the room use state changes. The system's room mode processing technology greatly improves low-frequency performance, delivering more balanced and powerful bass. Through innovative algorithm design and system architecture, it comprehensively addresses many challenges that traditional audio systems face in real-room environments. It not only accurately analyzes and compensates for the impact of room acoustic characteristics on the sound quality but also achieves intelligent dynamic optimization, providing strong technical support for users to obtain the best audio experience in various environments. The adaptive learning capability and real-time optimization features enable it to adapt to different acoustic environments, audio content and user preferences, representing a major leap forward in home audio system technology. Through rigorous performance testing and user evaluation, the system demonstrates outstanding performance and stability, and has the potential for broad application in the high-end audio market, pointing the way for future development of smart home audio technology.

In the present disclosure, by performing compensation processing, gain control processing and multi-channel collaborative optimization processing on the acoustic characteristic information obtained from analyzing the environmental response information, which is obtained from performing sound effect testing based on a specified measurement signal, precise compensation for acoustic defects in the target space is achieved, a crosstalk between channels is effectively addressed, the localization and spatial sense of a sound image are significantly enhanced, and thereby an overall listening experience for the audio is greatly improved, enabling adaptation to different listening environments and audio source types, continuously optimizing the audio output, and ensuring the best listening experience in various environments.

The present disclosure further provides a computer-readable storage medium, which may be a non-transitory computer-readable storage medium or a transitory computer-readable storage medium. The computer-readable storage medium may be a transitory computer-readable storage medium having stored therein a computer program, the computer program, when executed on a computer, causes the computer to implement the following steps: performing sound effect testing on a target space based on a specified measurement signal, and obtaining environmental response information, where the environmental response information includes impulse response information and post-separation impulse response information; analyzing the environmental response information, and obtaining acoustic characteristics information of the target space; performing compensation processing on audio to be processed based on the acoustic characteristic information, and obtaining adjusted audio; adjusting gains of a plurality of channels corresponding to the adjusted audio, and obtaining re-adjusted audio; and performing multi-channel collaborative optimization processing on the re-adjusted audio, and obtaining audio with a target effect.

In an implementation, performing sound effect testing on the target space based on the specified measurement signal and obtaining the environmental response information includes: collecting, by using a preset collection device array, response information of a plurality of measurement points in the target space for the specified measurement signal, where the plurality of measurement points forms a measurement grid; performing information extraction on the response information of the plurality of measurement points, and obtaining impulse response information corresponding to each of the plurality of measurement points; separating the impulse response information corresponding to each of the plurality of measurement points, and obtaining a direct sound, an early reflection and a reverberation tail corresponding to each of the plurality of measurement points; and determining the impulse response information, the direct sound, the early reflection, and the reverberation tail corresponding to each of the plurality of measurement points as the environmental response information of the target space.

In an implementation, analyzing the environmental response information and obtaining the acoustic characteristics information of the target space includes: performing spectrum analysis on the impulse response information in the environmental response information, and obtaining a spectrum analysis result, where the spectrum analysis result includes a frequency response curve and a power spectral density; identifying, based on the power spectral density, environmental mode parameters of the target space, where the environmental mode parameters include a modal density and a modal overlap degree; calculating, based on the reverberation tails corresponding to each of the plurality of measurement points, a reverberation time corresponding to each of the plurality of measurement points; analyzing the early reflection and the direct sound corresponding to each of the plurality of measurement points, and obtaining an early reflection analysis result corresponding to each of the plurality of measurement points; and determining the spectrum analysis result, the environmental mode parameters of the target space, the reverberation time and the early reflection analysis result corresponding to each of the plurality of measurement points as the acoustic characteristic information of the target space.

In an implementation, performing compensation processing on the audio to be processed based on the acoustic characteristic information and obtaining the adjusted audio includes: generating an adaptive equalization model based on the frequency response curve in the acoustic characteristic information, where the adaptive equalization model is used for band-limited adaptive filtering; generating an adaptive modal control model, where the adaptive modal control model is used for an environmental adaptive-dynamic control mode; performing optimization processing on the early reflection analysis result in the acoustic characteristic information, and obtaining optimized early reflection information; adjusting the reverberation time in the acoustic characteristic information, and obtaining adjusted reverberation time; and performing adjustment processing on the audio to be processed through the adaptive equalization model, the adaptive modal control model, the optimized early reflection information and the adjusted reverberation times, and obtaining the adjusted audio.

In an implementation, generating the adaptive equalization model based on the frequency response curve in the acoustic characteristic information includes: adjusting the frequency response curve in the acoustic characteristic information by using a specified standard curve, and obtaining a target response curve; generating a parametric equalization model based on the target response curve; and adjusting a parameter of the parametric equalization model by using a preset adaptive algorithm, and obtaining the adaptive equalization model.

In an implementation, generating the adaptive modal control model includes: identifying a mode type of the target space; setting a filter corresponding to the mode type; and adjusting a parameter of the filter corresponding to the mode type, and obtaining the adaptive modal control model.

In an implementation, performing optimization processing on the early reflection analysis result in the acoustic characteristic information and obtaining the optimized early reflection information includes: calculating, based on the early reflection analysis result in the acoustic characteristic information, a delay time and an energy attenuation value for each early reflection path; performing time alignment processing on the early reflection based on the delay time, and performing phase correction on the impulse response information, and obtaining processed information; obtaining a target sound field characteristic, where the target sound field characteristic is an ideal environmental acoustic characteristic; adjusting, based on the energy attenuation value and the target sound field characteristic, reflection energy in the early reflection analysis result, and obtaining adjusted reflection energy; and determining the processed information and the adjusted reflection energy as the optimized early reflection information.

In an implementation, adjusting the reverberation time in the acoustic characteristic information and obtaining the adjusted reverberation time includes: determining an ideal reverberation time according to a scenario type; generating a multi-channel feedback delay network, where the multi-channel feedback delay network is used to simulate natural reverberation; and adjusting, based on the ideal reverberation time and the multi-channel feedback delay network, the reverberation time in the acoustic characteristic information, and obtaining the adjusted reverberation time.

In an implementation, adjusting the gains of the plurality of channels corresponding to the adjusted audio and obtaining the re-adjusted audio includes: obtaining noise prediction information of the target space, where the noise prediction information is used to indicate noise levels at different time periods; adjusting, based on the noise prediction information, compression ratios and compression thresholds of the plurality of channels corresponding to the adjusted audio, and obtaining a plurality of adjusted channels; and performing, based on the plurality of adjusted channels, masking-based gain control on the adjusted audio, and obtaining the re-adjusted audio.

In an implementation, performing multi-channel collaborative optimization processing on the re-adjusted audio and obtaining the audio with the target effect includes: analyzing a channel cross-influence characteristic between the plurality of adjusted channels; performing phase compensation and amplitude compensation on the re-adjusted audio based on the channel cross-influence characteristic, and obtaining an equalized sound effect; and processing the equalized sound effect based on a preset adaptive cross-cancellation algorithm, and obtaining the audio with the target effect.

In an implementation, the method further includes: identifying a current audio use scenario, and automatically matching a control strategy corresponding to the audio use scenario, where the control strategy includes content of the acoustic characteristic information, compensation processing content and a compensation processing procedure.

In an implementation, after performing multi-channel collaborative optimization processing on the re-adjusted audio and obtaining the audio with the target effect, the method further includes: obtaining analysis data, and performing, based on the analysis data, a mechanism update and/or a strategy optimization for an audio control manner, where the analysis data includes performance test data and user evaluation data.

Those skilled in the art may clearly understand that, for the sake of convenience and brevity of description, the specific working process of the system and units mentioned above may be referred to the corresponding processes in the method embodiments, and thus the description thereof is omitted herein.

If the integrated unit is implemented in the form of software functional units and sold or used as an independent product, it may be stored in a computer readable storage medium. Based on this understanding, essence of the technical solutions of the present disclosure, or the part contributing to the prior art, or all or part of the technical solutions, may be embodied in the form of a software product. The computer software product is stored in a storage medium, and includes a number of computer programs to enable a computer device (which may be a personal computer, a server, or a network device, etc.) to perform all or part of the steps of method described in the various embodiments of the present disclosure. The storage medium includes a USB flash disk, a mobile hard disk, a read-only memory (Read-Only Memory, ROM), a random access memory (Random Access Memory, RAM), a magnetic disk, an optical disk, or other medium which can store program code.

The above embodiments are merely used to illustrate the technical solutions of the present disclosure, but shall not be construed as limiting the present disclosure. As can be appreciated by a person skilled in the art, although the present disclosure has been described in detail with reference to the foregoing embodiments, any modifications or variations of the technical solutions in the aforementioned embodiments, or equivalent replacements of part of the technical features within the scope of the disclosed technology, may still be made by those skilled in the art. These modifications, variations or replacements do not make the essence of the corresponding technical solutions depart from the spirit and scope of the technical solutions of the embodiments of the present disclosure.

What is claimed is:

1. A computer-implemented method for audio control, comprising:
performing sound effect testing on a target space based on a specified measurement signal, and obtaining environmental response information, wherein the environmental response information comprises impulse response information and post-separation impulse response information;
analyzing the environmental response information, and obtaining acoustic characteristics information of the target space;
performing compensation processing on audio to be processed based on the acoustic characteristic information, and obtaining adjusted audio;
adjusting gains of a plurality of channels corresponding to the adjusted audio, and obtaining re-adjusted audio; and
performing multi-channel collaborative optimization processing on the re-adjusted audio, and obtaining audio with a target effect.

2. The computer implementation method for audio control according to claim 1, wherein performing sound effect testing on the target space based on the specified measurement signal and obtaining the environmental response information comprises:
collecting, by using a preset collection device array, response information of a plurality of measurement points in the target space for the specified measurement signal, wherein the plurality of measurement points forms a measurement grid;
performing information extraction on the response information of the plurality of measurement points, and obtaining impulse response information corresponding to each of the plurality of measurement points;
separating the impulse response information corresponding to each of the plurality of measurement points, and obtaining a direct sound, an early reflection and a reverberation tail corresponding to each of the plurality of measurement points; and
determining the impulse response information, the direct sound, the early reflection, and the reverberation tail corresponding to each of the plurality of measurement points as the environmental response information of the target space.

3. The computer-implemented method for audio control according to claim 2, wherein analyzing the environmental response information and obtaining the acoustic characteristics information of the target space comprises:
performing spectrum analysis on the impulse response information in the environmental response information, and obtaining a spectrum analysis result, wherein the spectrum analysis result comprises a frequency response curve and a power spectral density;
identifying, based on the power spectral density, environmental mode parameters of the target space, wherein the environmental mode parameters comprise a modal density and a modal overlap degree;
calculating, based on the reverberation tails corresponding to each of the plurality of measurement points, a reverberation time corresponding to each of the plurality of measurement points;
analyzing the early reflection and the direct sound corresponding to each of the plurality of measurement points, and obtaining an early reflection analysis result corresponding to each of the plurality of measurement points; and
determining the spectrum analysis result, the environmental mode parameters of the target space, the reverberation time and the early reflection analysis result corresponding to each of the plurality of measurement points as the acoustic characteristic information of the target space.

4. The computer-implemented method for audio control according to claim 3, wherein performing compensation processing on the audio to be processed based on the acoustic characteristic information and obtaining the adjusted audio comprises:
generating an adaptive equalization model based on the frequency response curve in the acoustic characteristic information, wherein the adaptive equalization model is used for band-limited adaptive filtering;
generating an adaptive modal control model, wherein the adaptive modal control model is used for an environmental adaptive-dynamic control mode;
performing optimization processing on the early reflection analysis result in the acoustic characteristic information, and obtaining optimized early reflection information;
adjusting the reverberation time in the acoustic characteristic information, and obtaining adjusted reverberation time; and
performing adjustment processing on the audio to be processed through the adaptive equalization model, the adaptive modal control model, the optimized early reflection information and the adjusted reverberation times, and obtaining the adjusted audio.

5. The computer-implemented method for audio control according to claim 4, wherein generating the adaptive equalization model based on the frequency response curve in the acoustic characteristic information comprises:
adjusting the frequency response curve in the acoustic characteristic information by using a specified standard curve, and obtaining a target response curve;
generating a parametric equalization model based on the target response curve; and
adjusting a parameter of the parametric equalization model by using a preset adaptive algorithm, and obtaining the adaptive equalization model.

6. The computer-implemented method for audio control according to claim 4, wherein generating the adaptive modal control model comprises:
identifying a mode type of the target space;
setting a filter corresponding to the mode type; and
adjusting a parameter of the filter corresponding to the mode type, and obtaining the adaptive modal control model.

7. The computer-implemented method for audio control according to claim 4, wherein performing optimization processing on the early reflection analysis result in the acoustic characteristic information and obtaining the optimized early reflection information comprises:
calculating, based on the early reflection analysis result in the acoustic characteristic information, a delay time and an energy attenuation value for each early reflection path;
performing time alignment processing on the early reflection based on the delay time, and performing phase correction on the impulse response information, and obtaining processed information;
obtaining a target sound field characteristic, wherein the target sound field characteristic is an ideal environmental acoustic characteristic;
adjusting, based on the energy attenuation value and the target sound field characteristic, reflection energy in the early reflection analysis result, and obtaining adjusted reflection energy; and
determining the processed information and the adjusted reflection energy as the optimized early reflection information.

8. The computer-implemented method for audio control according to claim 4, wherein adjusting the reverberation time in the acoustic characteristic information and obtaining the adjusted reverberation time comprises:
determining an ideal reverberation time according to a scenario type;
generating a multi-channel feedback delay network, wherein the multi-channel feedback delay network is used to simulate natural reverberation; and
adjusting, based on the ideal reverberation time and the multi-channel feedback delay network, the reverberation time in the acoustic characteristic information, and obtaining the adjusted reverberation time.

9. The computer-implemented method for audio control according to claim 1, wherein adjusting the gains of the plurality of channels corresponding to the adjusted audio and obtaining the re-adjusted audio comprises:
obtaining noise prediction information of the target space, wherein the noise prediction information is used to indicate noise levels at different time periods;
adjusting, based on the noise prediction information, compression ratios and compression thresholds of the plurality of channels corresponding to the adjusted audio, and obtaining a plurality of adjusted channels; and
performing, based on the plurality of adjusted channels, masking-based gain control on the adjusted audio, and obtaining the re-adjusted audio.

10. The computer-implemented method for audio control according to claim 9, wherein performing multi-channel collaborative optimization processing on the re-adjusted audio and obtaining the audio with the target effect comprises:
analyzing a channel cross-influence characteristic between the plurality of adjusted channels;
performing phase compensation and amplitude compensation on the re-adjusted audio based on the channel cross-influence characteristic, and obtaining an equalized sound effect; and
processing the equalized sound effect based on a preset adaptive cross-cancellation algorithm, and obtaining the audio with the target effect.

11. The computer-implemented method for audio control according to claim 1, wherein before performing the sound test on the target space based on the specified measurement signal and obtaining the environmental response information, the method further comprises:
identifying a current audio use scenario, and automatically matching a control strategy corresponding to the audio use scenario, wherein the control strategy comprises content of the acoustic characteristic information, compensation processing content and a compensation processing procedure.

12. The computer-implemented method for audio control according to claim 1, wherein after performing multi-channel collaborative optimization processing on the re-adjusted audio and obtaining the audio with the target effect, the method further comprises:
obtaining analysis data, and performing, based on the analysis data, a mechanism update and/or a strategy optimization for an audio control manner, wherein the analysis data comprises performance test data and user evaluation data.

13. An electronic device, comprising: a processor and a memory, wherein the memory has stored therein instructions executable by the processor, and the instructions, when executed by the processor, cause the processor to perform the following steps:
performing sound effect testing on a target space based on a specified measurement signal, and obtaining environmental response information, wherein the environmental response information comprises impulse response information and post-separation impulse response information;
analyzing the environmental response information, and obtaining acoustic characteristics information of the target space;
performing compensation processing on audio to be processed based on the acoustic characteristic information, and obtaining adjusted audio;
adjusting gains of a plurality of channels corresponding to the adjusted audio, and obtaining re-adjusted audio; and
performing multi-channel collaborative optimization processing on the re-adjusted audio, and obtaining audio with a target effect.

14. The electronic device according to claim 13, wherein performing sound effect testing on the target space based on the specified measurement signal and obtaining the environmental response information comprises:
collecting, by using a preset collection device array, response information of a plurality of measurement points in the target space for the specified measurement signal, wherein the plurality of measurement points forms a measurement grid;
performing information extraction on the response information of the plurality of measurement points, and obtaining impulse response information corresponding to each of the plurality of measurement points;
separating the impulse response information corresponding to each of the plurality of measurement points, and obtaining a direct sound, an early reflection and a reverberation tail corresponding to each of the plurality of measurement points; and
determining the impulse response information, the direct sound, the early reflection, and the reverberation tail corresponding to each of the plurality of measurement points as the environmental response information of the target space.

15. The electronic device according to claim 14, wherein analyzing the environmental response information and obtaining the acoustic characteristics information of the target space comprises:
performing spectrum analysis on the impulse response information in the environmental response information, and obtaining a spectrum analysis result, wherein the spectrum analysis result comprises a frequency response curve and a power spectral density;
identifying, based on the power spectral density, environmental mode parameters of the target space, wherein the environmental mode parameters comprise a modal density and a modal overlap degree;
calculating, based on the reverberation tails corresponding to each of the plurality of measurement points, a reverberation time corresponding to each of the plurality of measurement points;
analyzing the early reflection and the direct sound corresponding to each of the plurality of measurement points, and obtaining an early reflection analysis result corresponding to each of the plurality of measurement points; and
determining the spectrum analysis result, the environmental mode parameters of the target space, the reverberation time and the early reflection analysis result corresponding to each of the plurality of measurement points as the acoustic characteristic information of the target space.

16. The electronic device according to claim 15, wherein performing compensation processing on the audio to be processed based on the acoustic characteristic information and obtaining the adjusted audio comprises:
generating an adaptive equalization model based on the frequency response curve in the acoustic characteristic information, wherein the adaptive equalization model is used for band-limited adaptive filtering;
generating an adaptive modal control model, wherein the adaptive modal control model is used for an environmental adaptive-dynamic control mode;
performing optimization processing on the early reflection analysis result in the acoustic characteristic information, and obtaining optimized early reflection information;
adjusting the reverberation time in the acoustic characteristic information, and obtaining adjusted reverberation time; and
performing adjustment processing on the audio to be processed through the adaptive equalization model, the adaptive modal control model, the optimized early reflection information and the adjusted reverberation times, and obtaining the adjusted audio.

17. The electronic device according to claim 16, wherein generating the adaptive equalization model based on the frequency response curve in the acoustic characteristic information comprises:
adjusting the frequency response curve in the acoustic characteristic information by using a specified standard curve, and obtaining a target response curve;
generating a parametric equalization model based on the target response curve; and
adjusting a parameter of the parametric equalization model by using a preset adaptive algorithm, and obtaining the adaptive equalization model.

18. The electronic device according to claim 16, wherein generating the adaptive modal control model comprises:
identifying a mode type of the target space;
setting a filter corresponding to the mode type; and
adjusting a parameter of the filter corresponding to the mode type, and obtaining the adaptive modal control model.

19. The electronic device according to claim 16, wherein performing optimization processing on the early reflection analysis result in the acoustic characteristic information and obtaining the optimized early reflection information comprises:
calculating, based on the early reflection analysis result in the acoustic characteristic information, a delay time and an energy attenuation value for each early reflection path;
performing time alignment processing on the early reflection based on the delay time, and performing phase correction on the impulse response information, and obtaining processed information;
obtaining a target sound field characteristic, wherein the target sound field characteristic is an ideal environmental acoustic characteristic;
adjusting, based on the energy attenuation value and the target sound field characteristic, reflection energy in the early reflection analysis result, and obtaining adjusted reflection energy;
and determining the processed information and the adjusted reflection energy as the optimized early reflection information.

20. A non-transitory computer-readable storage medium having a computer program stored thereon, wherein the computer program, when executed by a processor, cause the processor to perform the following steps:
performing sound effect testing on a target space based on a specified measurement signal, and obtaining environmental response information, wherein the environmental response information comprises impulse response information and post-separation impulse response information;
analyzing the environmental response information, and obtaining acoustic characteristics information of the target space;
performing compensation processing on audio to be processed based on the acoustic characteristic information, and obtaining adjusted audio;
adjusting gains of a plurality of channels corresponding to the adjusted audio, and obtaining re-adjusted audio; and
performing multi-channel collaborative optimization processing on the re-adjusted audio, and obtaining audio with a target effect.
